(19) United States
(12) Patent Application Publication
(10) Pub. No.: US 2005/0103387 A1
(43) Pub. Date: May 19, 2005

(54) Quick connect apparatus

(76) Inventors: James A. Voege, Carmel, IN (US); David A. Ferrer, Westfield, IN (US)

Correspondence Address: BAKER & DANIELS, 300 NORTH MERIDIAN STREET, SUITE 2700, INDIANAPOLIS, IN, 46204-1782, US

(21) Appl. No.: 10/988,862

(22) Filed: Nov. 15, 2004

Related U.S. Application Data
(60) Provisional application No. 60/520,448, filed on Nov. 14, 2003.

(51) Int. Cl. F16L 37/32

(52) U.S. Cl. 137/614.04

(57) ABSTRACT

Connectors for use with a fluid storage device are disclosed. The connectors may be female connectors or male connectors. An adapter to connect connectors of differing sizes is also disclosed.

### RELATED APPLICATIONS

This application claims the benefit of U.S. Provisional Application Ser. No. 60/520,448, filed Nov. 14, 2003, Attorney Docket No. 11765-0008, titled “Quick Connect Apparatus for Liquid Oxygen Systems”, the disclosure of which is expressly incorporated by reference herein.

### BACKGROUND

The present invention relates to connectors and in particular to connectors for liquid oxygen systems.

People who require additional oxygen for proper breathing rely on portable oxygen tanks or units to permit greater mobility. The portable oxygen tank provides a flow of oxygen to the user, either steady or intermittent, as is well known in the art. An exemplary portable oxygen tank is the HELiOS H300 Portable Unit available from Puritan Bennett located at 4280 Hacienda Drive, Pleasanton, Calif. 94588 and on the Internet at http://www.puritanbennett.com.

The portable oxygen tank must be filled with or otherwise includes oxygen to permit proper operation. The HELiOS H300 unit described above is filled with liquid oxygen from a reservoir containing liquid oxygen. An exemplary liquid oxygen reservoir is the HELiOS H36/H46 Liquid Oxygen Reservoir also available from Puritan Bennett. Literature related to the operation of both the HELiOS H300 Portable Unit and the HELiOS H36/H46 Liquid Oxygen Reservoir is provided as an attachment to U.S. Provisional Application Ser. No. 60/520,448, filed Nov. 14, 2003, Attorney Docket No. 11765-0008, titled “Quick Connect Apparatus for Liquid Oxygen Systems”, the disclosure of which is expressly incorporated by reference herein.

FIG. 1 illustrates a prior art liquid oxygen system 10, the Puritan Bennett HELiOS system. Liquid oxygen system 10 includes a HELiOS H300 Portable Unit 12 and a HELiOS H36/H46 Liquid Oxygen Reservoir 14. Portable Unit 12 includes a female connector 16. Reservoir 14 includes a male connector 18. When portable unit 12 is to be filled with oxygen, male connector 18 is received by female connector 16 to permit oxygen to pass from reservoir 14 to portable unit 12 through male connector 18 and female connector 16.

Male connector 18 includes a body member 20 including a cylindrical portion 22, a tool engaging portion 24 (illustratively being a hex shape), and a threaded portion 26. Threaded portion 26 is configured to be received in a threaded aperture (not shown) of reservoir 14. Male connector 18 further includes an internal channel 28 which when male connector 18 is connected to reservoir 14 is in fluid communication with the oxygen supply stored in reservoir 14. Disposed within channel 28 is a valve 30 including a valve shaft 32 and a seal 34. Valve shaft 32 is received by a shaft guide 36 which is retained within internal channel 28 by a retaining ring 38. Shaft guide 36 includes multiple openings such that a first portion 27 of internal channel 28 is in constant fluid communication with a second position 29 of internal channel 28.

Valve 30 is moveable along a longitudinal axis 19 of connector 18 generally in directions 40, 41. However, valve 30 is biased in direction 40 by a spring 42. Spring 42 is compressed between a flange 33 of valve shaft 32 and shaft guide 36. As shown in FIG. 1, seal 34 of valve 30 contacts an end portion 44 of internal channel 28 when valve 30 is biased in direction 40. When seal 34 is properly seated against end portion 44, seal 34 prevents oxygen from internal channel 28 from passing into the atmosphere, generally denoted as 46. As such, when seal 34 is properly seated against end portion 44, fluid from reservoir 14 may pass into second portion 29 of internal channel 28, but is prevented from passing into atmosphere 46.

An end portion 31 of valve 30 extends beyond body portion 20 when seal 34 is sealed against end portion 44. By pressing end portion 31 in direction 41, spring 42 is further compressed and seal 34 is spaced apart from end portion 44 such that valve 30 is open.

Female connector 16 includes a body portion 50, a sleeve 52, a hex nut 54, and a jam nut 56. Hex nut 54 is threadably coupled to body portion 50. Sleeve 52 is threadably coupled to body portion 50. Hex nut 54 and jam nut 56 cooperate to couple female connector 16 to portable unit 12. When connected to portable unit 12, an internal channel 55 of hex nut 54 is in fluid communication with the oxygen supply stored in portable unit 12.

Body portion 50 includes an internal channel 58 which is in fluid communication with the oxygen supply stored in portable unit 12 through internal channel 55 of hex nut 54. Disposed within channel 58 is a valve 60 including a valve shaft 62 and a seal 64. Valve shaft 62 is received by a shaft guide 66 which is retained within internal channel 58 by a retaining ring 68. Shaft guide 66 includes multiple openings such that a first portion 57 of internal channel 58 is in constant fluid communication with a second portion 59 of internal channel 58.

Valve 60 is moveable along a longitudinal axis of female connector 16 generally in directions 70, 71. However, valve 60 is biased in direction 71 by a spring 72. Spring 72 is compressed between a flange 63 of valve shaft 62 and shaft guide 66. As shown in FIG. 1, seal 64 of valve 60 contacts an end portion 74 of internal channel 58 when valve 60 is biased in direction 71. When seal 64 is properly seated against end portion 74, seal 64 prevents oxygen from internal channel 58 from passing into the atmosphere, generally denoted as 46. As such, when seal 64 is properly seated against end portion 74, fluid from portable unit 12 may pass into second portion 59 of internal channel 58, but is prevented from passing into atmosphere 46.

Female connector 16 further includes a recess 80 sized to receive cylindrical portion 22 of male connector 18. Recess 80 is comprised of an internal channel 82 of sleeve 52 and a recess 84 of body portion 50. An end portion 61 of valve 60 extends into recess 80 when seal 64 is seated against end portion 74. By pressing end portion 61 in direction 70, spring 72 is further compressed and seal 64 is spaced apart from end portion 74 such that valve 60 is open.

Referring to FIG. 2, when male connector 18 is inserted into recess 80 end portion 31 of valve 30 of male connector 18 and end portion 61 of valve 60 of female connector 16 are brought into contact. Further movement of cylindrical portion 22 into recess 80 results in valve 30 of male connector 18 being moved in direction 41 and valve 60 of female connector 16 being moved in direction 70. Due to such movement, seal 34 is spaced apart from end portion 44 (valve 30 is opened) and seal 64 is spaced apart from end portion 74 (valve 60 is opened) resulting in internal channel 28 of male connector 18 being in fluid communication with internal channel 58 of female connector 16 such that oxygen flows from reservoir 14 to portable unit 12, as represented by flow path 90.

Female connector 16 further includes a spring energized lip seal 92 which is positioned in recess 80 such that it is contactable by cylindrical portion 22 of male connector 18. Lip seal 92 is received in a enlarged portion 94 of recess 84 and is held in place by sleeve 52. Spring energized lip seal 92 provides a seal between cylindrical member 22 and the walls of recess 80.

### BRIEF DESCRIPTION OF THE DRAWINGS

Additional features of the invention will become apparent to those skilled in the art upon consideration of the following detailed description of illustrated embodiments exemplifying the best mode of carrying out the invention as presently perceived.

FIG. 1 illustrates a prior art liquid oxygen system wherein a portable unit is to be connected to a reservoir through a connector, the connector being shown in a sectional view and including a male connector and a female connector;

FIG. 2 illustrates the prior art liquid oxygen system of FIG. 1 wherein the portable unit is connected to the reservoir through the connector, a portion of the male connector being received into a recess of the female connector;

FIG. 3 is a first female connector including multiple seals positioned in a recess configured to receive a male connector;

FIG. 4 is a connector configured to connect a reservoir containing fluid to a portable unit such that fluid is communicated from the reservoir to the portable unit, the connector shown in sectional view including a female connector and a male connector;

FIG. 5 is an exploded view of the female connector of FIG. 4;

FIG. 6 is an exploded view of the male connector of FIG. 4;

FIG. 7 illustrates the connector of FIG. 4 wherein the female connector and male connector are connected together to permit fluid communication between the reservoir and the portable unit;

FIG. 8 illustrates in sectional view a female connector of a first sized connected to a male connector of a second size through an adapter, the second size being larger than the first size;

FIG. 9 is an exploded view of the adapter of FIG. 8;

FIG. 10 illustrates in sectional view a female connector of a first sized connected to a male connector of a second size through an adapter, the second size being smaller than the first size;

FIG. 11 is an exploded view of the adapter of FIG. 10;

FIG. 12 is a sectional view of a cover for the male connector 18 of FIG. 4; and

FIG. 13 illustrates the female connector and the male connector of FIG. 1 along with some dimensions of the female connector and the male connector.

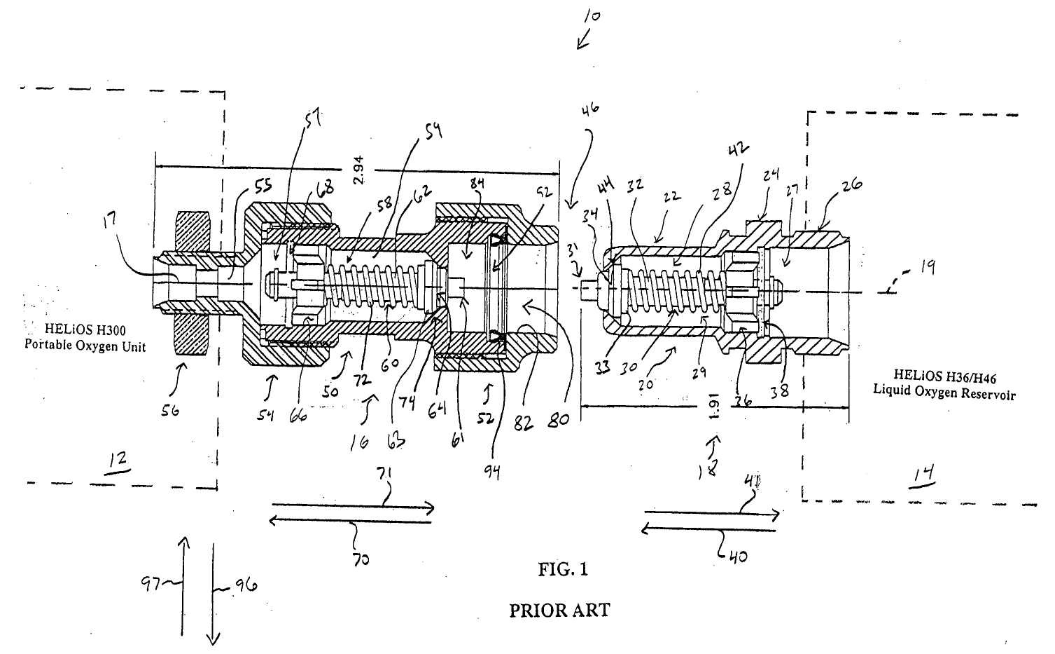

### DETAILED DESCRIPTION

While the invention is susceptible to various modifications and alternative forms, exemplary embodiments thereof have been shown by way of example in the drawings and will herein be described in detail.

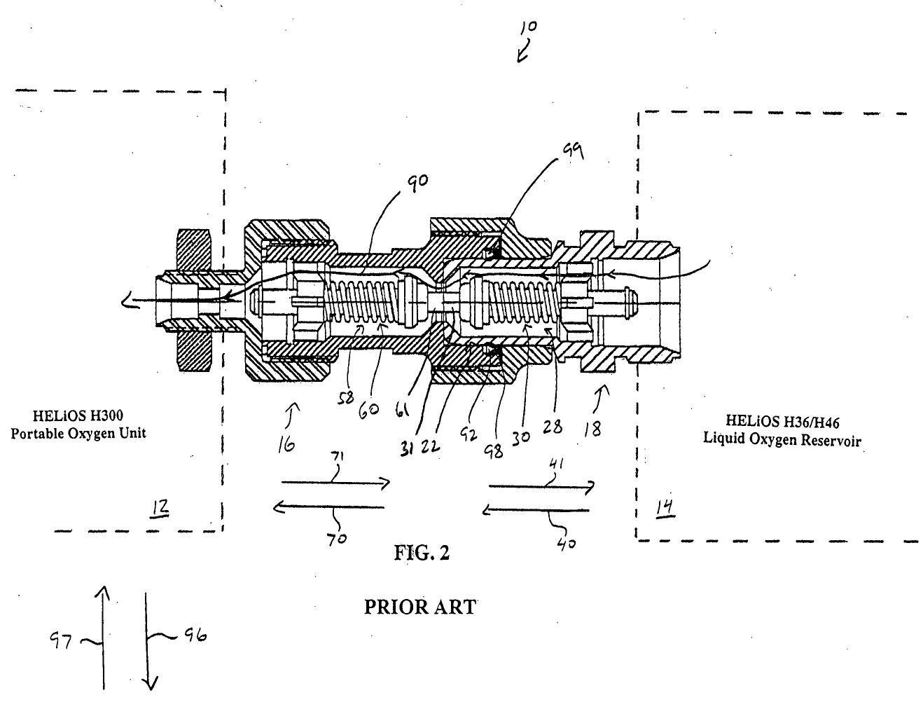

When a transverse load in direction 96 or 97 (shown in FIG. 2) is exerted on at least one of portable unit 12 and reservoir 14, such a transverse load may result in an incomplete seal between cylindrical portion 22 of male connector 18 and spring energized lip seal 92 of female connector 16. For example, if a transverse load is exerted on male connector 18 in direction 96, male connector 16 may pivot about lip seal 92 and/or further compress a portion 98 of lip seal 92 between recess 94 and cylindrical portion 22 such that a gap between lip seal 92 and cylindrical portion 22 is created near portion 99 of lip seal 92.

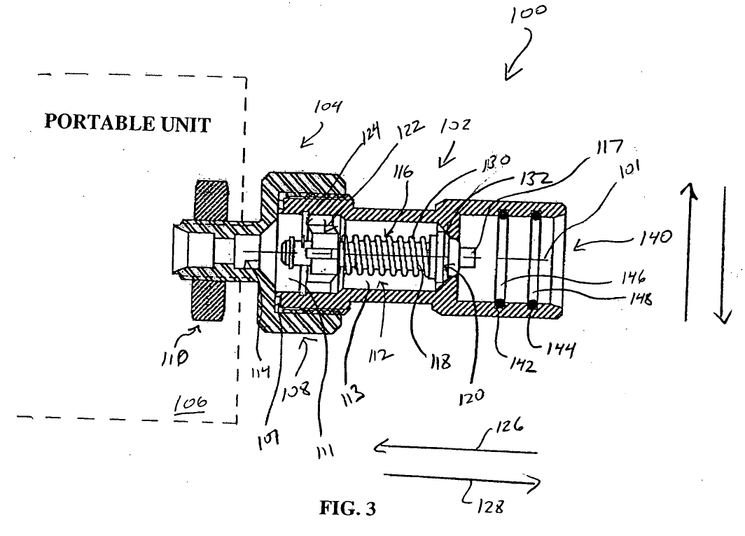

Referring to FIG. 3, a female connector 100 is shown. Female connector 100 includes a body portion 102 and a coupler 104. Coupler 104 couples female connector 100 to a portable liquid oxygen unit 106. In one example, portable liquid oxygen unit 106 is the HELiOS H300 Portable Unit described herein. In the illustrated embodiment, coupler 104 includes a hex nut 108 and a jam nut 110. Hex nut 108 is threadably coupled to body portion 102. A seal 107 is positioned between body portion 102 and hex nut 108. Hex nut 108 and jam nut 110 cooperate to couple body portion 102 to portable liquid oxygen unit 106. In alternative embodiments, body portion 102 is threadably received in a threaded aperture of portable unit 106, body portion 102 is welded to portable unit 106, or coupler 104 is one of a snap fitting, a latch, or other suitable couplers.

Body portion 102 includes an internal channel 112 which is in fluid communication with the oxygen supply stored in portable unit 106 through an internal channel 114 of hex nut 108. Disposed within channel 112 is a valve 116 including a valve shaft 118 and a seal 120. Valve shaft 118 is received by a shaft guide 122 which is retained within internal channel 112 by a retaining ring 124. Shaft guide 122 includes one or more openings such that a first portion 111 of internal channel 112 is in constant fluid communication with a second portion 113 of internal channel 112.

Valve 116 is moveable along a longitudinal axis 101 of connector 100 generally in directions 126, 128. However, valve 116 is biased in direction 128 by a spring 130. Spring 130 is compressed between a flange 119 of valve shaft 118 and shaft guide 122. As shown in FIG. 3, seal 120 of valve 116 contacts an end portion 132 of internal channel 112 when valve 116 is biased in direction 128. When seal 120 is seated against end portion 132, seal 120 prevents oxygen from internal channel 112 from passing into the atmosphere generally denoted as 46.

Female connector 100 further includes a recess 140 sized to receive a portion of a male connector, such as cylindrical portion 22 of male connector 18. An end portion 117 of valve 116 extends into recess 140 when seal 120 is sealed against end portion 132. By pressing end portion 117 in direction 126, spring 130 is further compressed and seal 120 is spaced apart from end portion 132 such that valve 30 is open.

Recess 140 includes spaced apart enlarged portions 142, 144. Enlarged portions 142, 144 are sized to receive seals 146, 148, respectively. In one example, seals 146, 148 are O-rings, such as Teflon O-rings. In another example, the O-rings are made of KEL F. In yet another example, seals 146, 148 are spring energized seals, similar to seal 34.

Enlarged portions 142, 144 and hence seals 146, 148 are spaced apart along longitudinal axis 101 of female connector 100. As such, seals 146, 148 provide two spaced apart sealing points for cylindrical portion 22 of male connector 18. By providing two sealing points along longitudinal axis 101 of female connector 100, seals 146, 148 reduce the likelihood that longitudinal axis 19 of male connector 18 becomes non-parallel to longitudinal axis 101 of female coupler 100 due to a transverse load on one of male connector 18 or female connector 100. In alternative embodiments, three or more seals, similar to seals 146, 148 are provided along with a corresponding number of enlarged portions, similar to enlarged portions 142, 144 resulting in three or more spaced apart sealing points between female connector 100 and a corresponding male connector 18.

An incomplete seal between seal 34 and end portion 44 of male connector 18 or between seal 64 and end portion 74 of female connector 18 could result in a loss of fluid to atmosphere 46 from the respective portable unit 12 or reservoir 14. Incomplete sealing between seal 34 and end portion 44 may result from valve shaft 32 not remaining parallel with longitudinal axis 19 of male connector 18 due to shaft guide 36 being distal to seal 34. This cantilevered arrangement can result in seal 34 not properly sealing against end portion 44. A similar incomplete sealing may occur between seal 64 and end portion 74 of female connector 16.

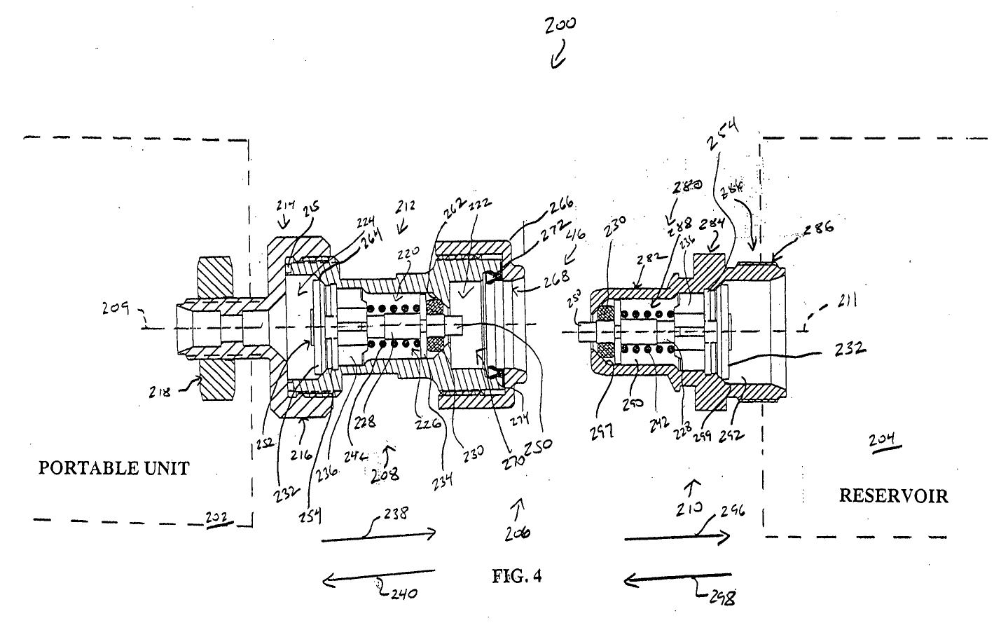

Referring to FIGS. 4-7, a liquid oxygen system 200 is shown wherein a portable unit 202 is connected to a reservoir 204 by a connector 206. Connector 206 includes a female connector 208 and a male connector 210. In one example, portable liquid oxygen unit 202 is the HELiOS H300 Portable Unit described herein and reservoir 204 is the HELiOS H36/H46 Liquid Oxygen Reservoir.

As explained in more detail below, female connector 208 and male connector 210 each include a valve which is sealed in multiple locations and/or which includes multiple guide members to minimize any deviation of the respective valve shaft from longitudinal axis 209, 211 of respective connector 208, 210. Although, female connector 208 and male connector 210 are described as having valves with multiple seals and with multiple guide members, it should be understood that either or both of female connector 208 and male connector 210 may have valves with multiple seals and a single guide member or valves with a single seal and multiple guide members.

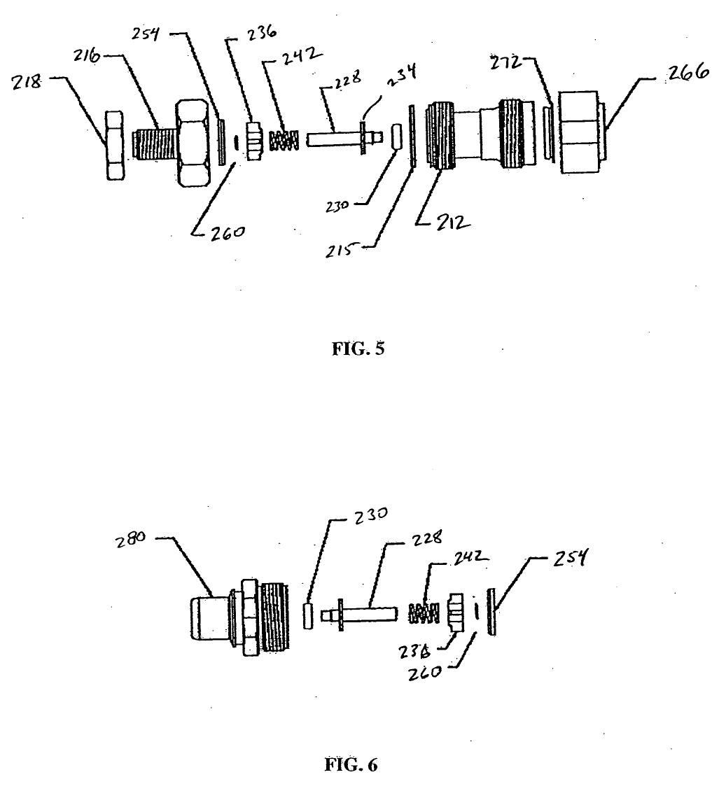

Referring to FIGS. 4 and 5, female connector 208 includes a body portion 212 and a coupler 214. Coupler 214 couples body portion 212 to portable unit 202. In the illustrated embodiment, coupler 214 includes a hex nut 216 threadably coupled to body portion 212 and a jam nut 218. A seal 215 is provided between hex nut 216 and jam nut 218. Jam nut 218 and hex nut 216 cooperate to couple portable unit 202. In alternative embodiments, body portion 212 is threadably received in a threaded aperture of portable unit 202, body portion 212 is welded to portable unit 202, or coupler 214 is one of a snap fitting, a latch, or other suitable couplers.

As shown in FIG. 4, body member 212 includes an internal channel 220, a first recess 222, and a second recess 224. Disposed within internal channel 220 is a valve 226 which includes a valve shaft 228, a first seal 230, a second seal 232, a first guide member 234, and a second guide member 236. Valve 226 is moveable parallel to longitudinal axis 209 of connector 208 generally in directions 238, 240. However, valve 226 is biased in direction 238 by a biasing member, such as spring 242. Spring 242 is positioned between first guide member 234 and second guide member 236 and is biased to increase the separation between first guide member 234 and second guide member 236.

Referring to FIG. 5, first guide member 234 is a flange portion of valve shaft 228. The diameter of first guide member 234 is chosen to generally approximate the diameter of internal channel 220. In another example, first guide member 234 is a separate component and is positioned against a flange of valve shaft 228 and is held in place by spring 242. Further, first guide member 234 is positioned generally proximate to a first end 250 of valve shaft 228. Referring to FIG. 4, second guide member 236 is positioned generally proximate to a second end 252 of valve shaft 228 and is retained by a retaining ring 254. As such, valve shaft 228 is guided proximate to first end 250 by first guide member 234 and is guided proximate to second end 252 by second guide member 236. By guiding valve shaft 228 at two spaced apart locations, the likelihood that valve shaft 228 will become non-parallel with longitudinal axis 219 of female connector 208 is reduced.

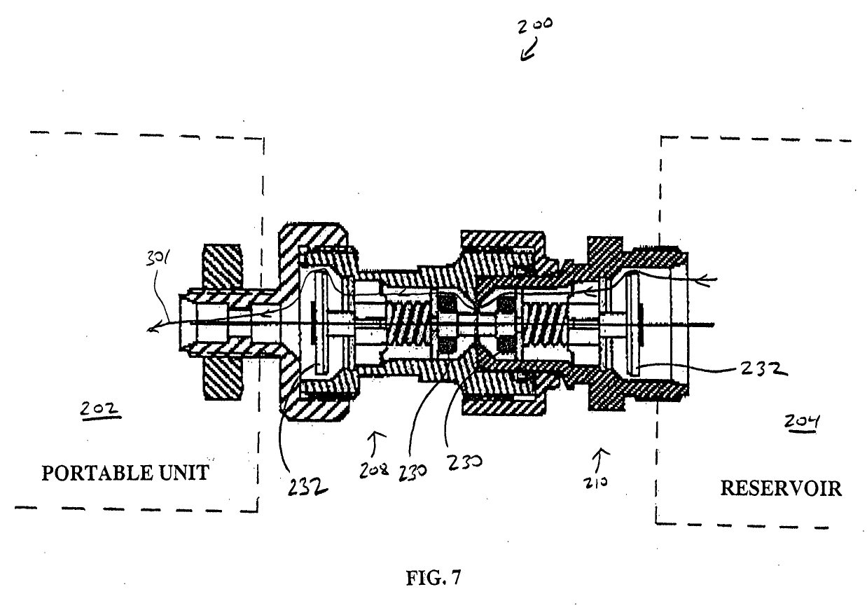

Referring to FIG. 7, valve 220 is shown in an open position. As shown in FIG. 7, first guide member 234 is fixably coupled to valve shaft 228 and hence moves generally in direction 240 along with valve shaft 228. In contrast, second guide member 236 generally remains in the same position between the closed position (FIG. 4) of valve 220 and the open position (FIG. 7) of valve 220. In one example, second guide member 236 is coupled to body portion 212. In another example, second guide member 236 is moveable relative to body portion 212, but is retained in approximately the same position due to the presence of retaining ring 254 and the force exerted by spring 242.

First guide member 234 and second guide member 236 each include one or more openings that permit fluid to flow from one side of the respective guide member to the other side of the respective guide member. In one example, first guide member 234 and second guide member 236 each have a cross-shaped cross section such that each of first guide member 234 and second guide member 236 includes four opening that permit the flow of fluid. Further, in some examples first guide member 234 and/or second guide member 236 include a central passage sized to receive valve shaft 228.

For instance, in the illustrated embodiment second guide member 236 includes a central passage (not shown) whose diameter is generally approximate to the diameter of valve shaft 228. It should be noted that connectors 208, 210 are generally exposed to temperature swings from approximately room temperature to approximately −300° F. (the temperature of the O₂ fluid passing through connectors 208, 210). As such, the rates of expansion for the materials of valve shaft 228, first guide member 234, second guide member 236, and body member 212 must be chosen such that valve shaft 228 is both moveable and properly guided throughout the temperature range. In an exemplary embodiment, valve shaft 228 is made of stainless steel. In an exemplary embodiment, first guide member 234 is made of stainless steel. In an exemplary embodiment, second guide member 236 is made of stainless steel. In an exemplary embodiment, body member 212 is made of aluminum.

Referring to FIG. 4, first seal 230 is positioned between first guide member 234 and first end 250 of valve shaft 228. In one example, first seal 230 is a O-ring seal and is press fit onto valve shaft 228, coupled to valve shaft 228, and/or coupled to first guide member 234. In one example, the O-ring of first seal 230 is a round O-ring. In the illustrated example, the O-ring of first seal 230 is a square O-ring. Suitable materials for the O-ring of first seal 230 include KEL F and a glass-filled Teflon.

Second seal 232 is positioned between second guide member 236 and second recess 224. In one example, second seal 232 is a disk shaped seal and is press fit onto valve shaft 228, coupled to valve shaft 228, and/or retained on valve shaft 228 by a retainer 260, such as the retaining clip shown in FIG. 5. Suitable materials for the O-ring of first seal 230 include KEL F and a glass-filled Teflon.

Referring to FIG. 4, first seal 230 prevents fluid from traveling between internal channel 220 and first recess 222 when valve 226 is biased in direction 238. First seal 230 seals against angled surface 262 of body member 212. Further, second seal 232 prevents fluid from traveling between internal channel 220 and second recess 224 when valve 226 is biased in direction 238. Second seal 232 seals against angled surface 264 of body member 212. First seal 230 and second seal 232 provide two seal locations between the atmosphere, generally denoted as 46, and portable unit 202 when valve 226 is biased in direction 238. Further, first seal 230 and second seal 232 permit fluid flow between first recess 222 and second recess 224 when valve 226 is moved in direction 240. Referring to FIG. 7, first seal 230 and second seal 232 each move with valve shaft 228 as valve shaft 228 moves in directions 238, 240.

Female connector 208, as discussed above, includes at least a double seal (first seal 230 and second seal 232) between portable unit 202 and atmosphere 46 and a valve shaft which is guided in at least two locations along its length (first guide member 234 and second guide member 236). It is further contemplated, in one embodiment, that valve shaft 62 be used in place of valve shaft 228, resulting in a connector that includes at least a double seal (first seal 230 and second seal 232) and a single guide (second guide member 236). It is yet further contemplated, in one embodiment, to provide only a single seal (first seal 230) and a valve shaft which is guided in at least two locations along its length (first guide member 234 and second guide member 236).

Referring to FIGS. 4 and 6, male connector 210 includes a body portion 280 including a cylindrical portion 282, a tool engaging portion 284 (illustratively shown to be hex shaped), and a threaded portion 286. Threaded portion 286 is received in a threaded aperture (not shown) of reservoir 204. In alternative embodiments, body portion 280 is welded to reservoir 204, or coupled to reservoir 204 with a hex nut and jam nut similar to female connector 208.

As shown in FIG. 4, body member 280 includes an internal channel 288 having a first portion 290 and a second portion 292. Disposed within internal channel 288 is a valve 294 which operates identical to valve 226 of female connector 208. As such like components have been identified with like numerals. Valve 294 is moveable parallel to longitudinal axis 211 of connector 210 generally in directions 296, 298. However, valve 294 is biased in direction 296 by a biasing member, such as spring 242.

Referring to FIG. 7, first seal 230 of male connector 210 prevents fluid from traveling between internal channel 288 and the atmosphere 46 when valve 294 is biased in direction 296. First seal 230 seals against angled surface 297 of body member 280. Further, second seal 232 of male connector 210 prevents fluid from traveling between first portion 290 of internal channel 288 and second portion 292 of internal channel 288 when valve 294 is biased in direction 296. Second seal 232 seals against angled surface 299 of body member 280. First seal 230 and second seal 232 provide two seal locations between the atmosphere, generally denoted as 46, and reservoir 204 when valve 294 is biased in direction 296. Further, first seal 230 and second seal 232 permit fluid flow between reservoir 204 and the atmosphere 46 when valve 294 is moved in direction 240.

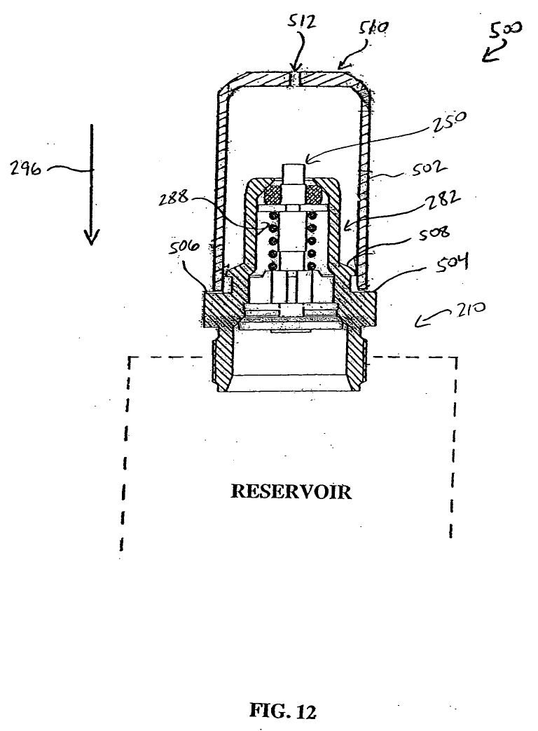

Referring to FIG. 12, a cover 500 is shown which is to placed over male connector 210 when the corresponding female connector is spaced apart to block inadvertent depression of end portion 250. Cover 500 includes a cylindrical sleeve 502 sized to fit over cylindrical member 282 of male connector 210. As shown in FIG. 12, an end surface 504 of cover 500 rests against a flange 506 of male connector 210. It should be appreciated that cover 500 may be sized to rest against other portions of male connector 210 such as flange 508. Further, cover 500 may be sized to block inadvertent depression of end portion 31 of male connector 18.

Cover 500 includes an end wall 510 which is spaced apart from end portion 250 of valve 288 when cover 500 rests on male connector 210. End wall 510 blocks inadvertent movement of valve 288 in direction 296. Cover 500 includes a vent opening 512 in end wall 510. In another example, end wall 510 is solid.

In alternative embodiments, to prevent inadvertent movement of valve 288 in direction 296, end portion 250 is flush with or recessed within body portion 280 of male connector 210 or male connector 210 is recessed within a recess of the reservoir. In such an example, end portion 250 of female connector 208 will be at least partially received by the opening in body portion 280 and as such must be tapered, include vanes, or otherwise provide a pathway for fluid to travel from male connector 210 into internal channel 220.

Male connector 210, as discussed above, includes at least a double seal (first seal 230 and second seal 232) between reservoir 204 and atmosphere 46 and a valve shaft which is guided in at least two locations along its length (first guide member 234 and second guide member 236). It is further contemplated, in one embodiment, that valve shaft 62 be used in place of valve shaft 228, resulting in a male connector 210 that includes at least a double seal (first seal 230 and second seal 232) and a single guide (second guide member 236). It is yet further contemplated, in one embodiment, to provide only a single seal (first seal 230) and a valve shaft which is guided in at least two locations along its length (first guide member 234 and second guide member 236).

Returning to female connector 208, a sleeve 266 is coupled to body member 212. Sleeve 266 includes an internal channel 268 which along with first recess 222 forms a recess 270 configured to receive cylindrical portion 282 of male connector 210. Female connector 208 further includes a seal 272, such as a spring energized lip seal, which is positioned in recess 270 such that it is contactable by cylindrical portion 282 of male connector 210. Lip seal 272 is received in a enlarged portion 274 of recess 270 and is held in place by sleeve 266. Spring energized lip seal 272 seals against cylindrical member 282 to prevent oxygen flowing from internal channel 288 into recess 270 and then to atmosphere 46 and to prevent oxygen flowing from internal channel 220 into recess 270 and then to atmosphere 46.

In another embodiment, female connector 208 includes an elongated body portion 212 including multiple enlarged recesses similar to female connector 100 shown in FIG. 3, instead of sleeve 266 and lip seal 272. As such, female 208 will include multiple spaced apart seals between recess 270 and cylindrical portion 282 of male connector 210.

Referring to FIG. 7, when male connector 210 is fully inserted into recess 270 valve 294 of male connector 210 and valve 226 of female connector 208 are in contact and valve 294 of male connector 210 is moved in direction 296 and valve 226 is moved in direction 240. Due to such movement, first seal 230 of female connector 208 is spaced apart from angled surface 262 and second seal 232 of female connector 208 is spaced apart from angled surface 264. Further, first seal 230 of male connector 210 is spaced apart from angled surface 297 and second seal 232 of male connector 210 is spaced apart from angled surface 299 resulting in interior channel 288 of male connector 210 being in fluid communication with internal channel 220 of female connector 208 such that oxygen flows from reservoir 204 to portable unit 202, as represented by flow path 301.

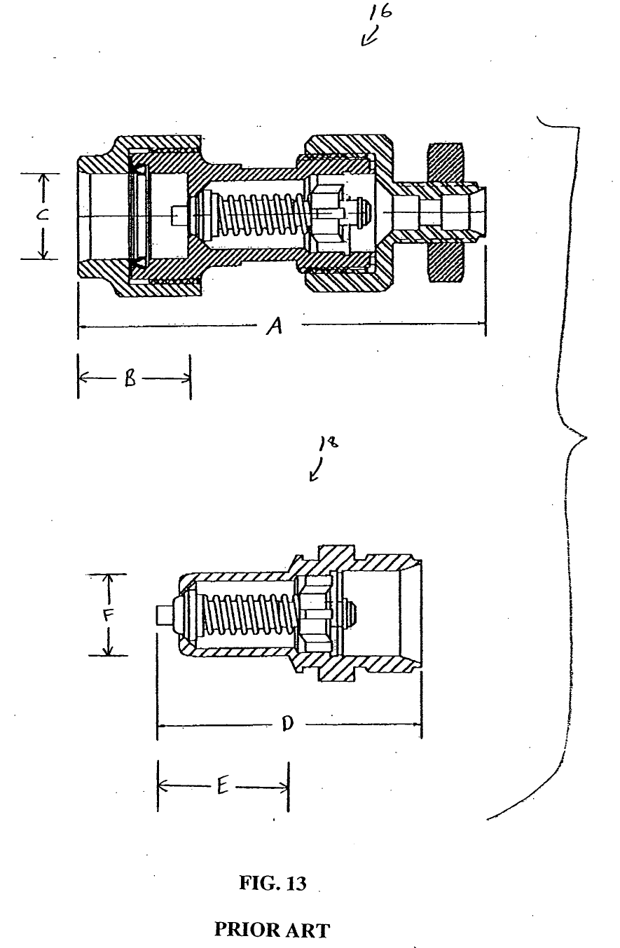

Various portable units and reservoir may have different size requirements for the connectors that are to be used therewith. For instance, turning to FIG. 13, the prior art HELiOS H300 portable unit 12 utilizes female connector 16 having a length A of 2.94 inches, a recess depth B of 0.803 inches, and a recess diameter C of 0.630 inches. The HELiOS H36/H46 reservoir 14 utilizes a male connector 18 having a length D of 1.91 inches, a cylindrical portion length E of 0.800 inches, and a cylindrical diameter F of 0.624 inches. As such, a novel male connector for use with female connector 16 must have a cylindrical portion length approximately equal to or greater than cylindrical portion length E and a cylindrical portion diameter approximately equal to the cylindrical portion diameter F of male connector 18. Further, a novel female connector for use with male connector 18 must have a recess depth approximately equal to or less than recess depth B and a recess diameter approximately equal to or greater than recess diameter C of female connector 16.

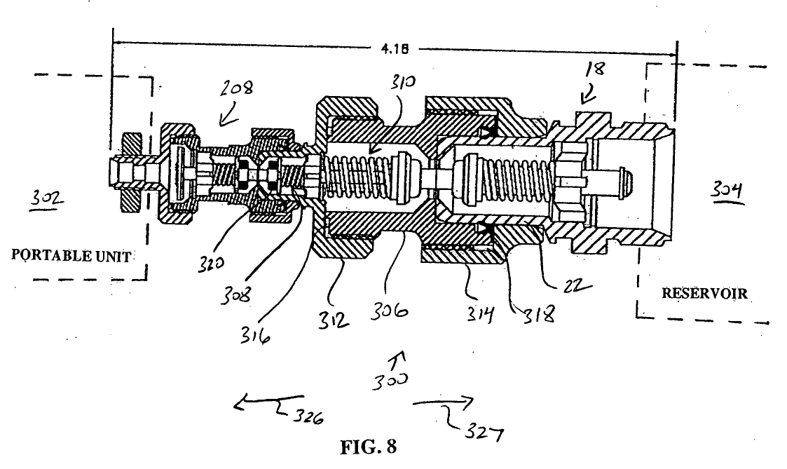

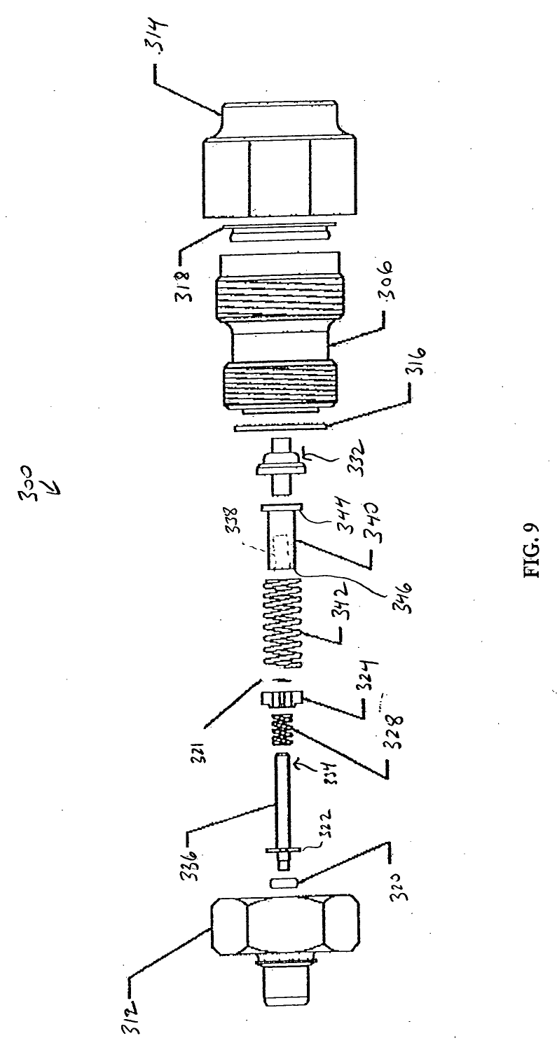

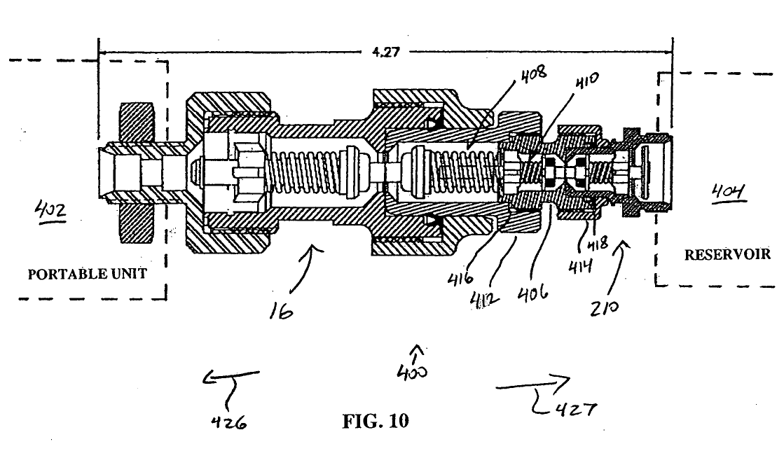

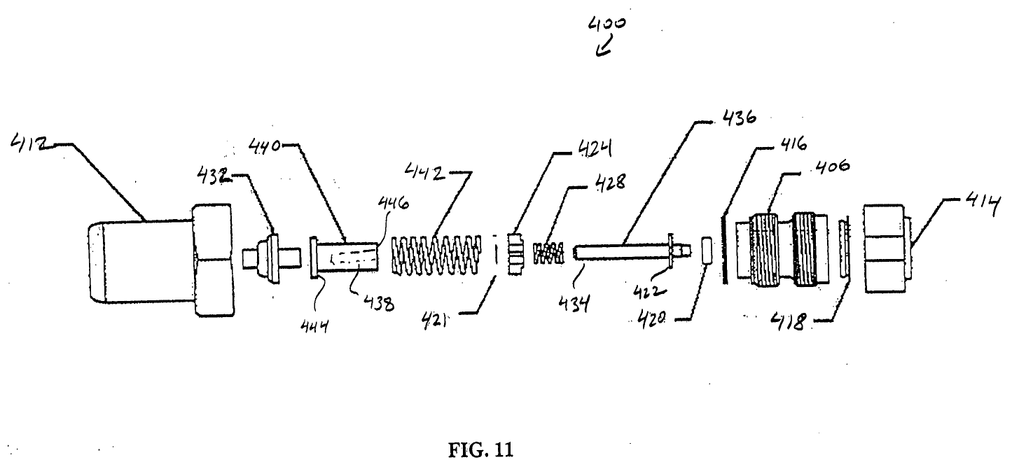

When a given male connector and a given female connector are a different size an adapter is contemplated to permit the coupling of the different size male connectors and female connectors. An adapter 300 is shown in FIGS. 8. and 9 for use in coupling a larger male connector, such as male connector 18, with a smaller female connector, such as female connector 208. An adapter 400 is shown in FIGS. 10 and 11 for use in coupling a smaller male connector, such as male connector 210, with a larger female connector, such as female connector 16.

Referring to FIG. 8, a portable unit 302 includes a female connector 208 and a reservoir 304 includes a male connector 18. Illustratively, female connector 208 is shown as being generally smaller than male connector 18 and not able to properly receive male connector 18 without the aid of adapter 300. However, it should be appreciated that female connector 208 may be the correct size to couple male connector 18 or may be larger than male connector 18 such that an adapter 400 is required.

Adapter 300 includes a body portion 306, a first valve 308, a second valve 310, a first sleeve 312, and a second sleeve 314. Seals 316 and 318 are provided between body portion 306 and first sleeve 312 and second sleeve 314, respectively. As shown in FIG. 8, first sleeve 312 is adapted to be received by recess 270 of female connector 208 and body portion 306 and second sleeve 314 cooperate to receive cylindrical portion 22 of male connector 18.

First valve 308 is illustratively shown as having a valve shaft 336 and associated retaining clip 321, a first seal 320, a first guide 322, and a second guide 324. In alternative embodiments, first valve 308 only includes a single guide, similar to female connector 16. Valve 308 is biased in direction 326 by a biasing member, spring 328. Spring 328 is compressed between first guide 322 and second guide 324.

Second valve 330 is illustratively shown as having a first seal 332 and a single guide 334. Single guide 334 is a portion of valve shaft 336 which is apart of first valve 308. Single guide 334 is received into a recess 338 of valve shaft 340 of second valve 330. Valve 330 is biased in direction 327 by a biasing member, spring 342. Spring 342 is compressed between guide 324 and flange 344 of valve shaft 340. It should be noted that an end 346 of valve shaft 340 is spaced apart from second guide 324 when valve 330 is in the closed position such that second guide member 324 does not block valve 330 from moving to the open position in direction 326. In alternative embodiments, second valve 330 includes multiple guides, such as guide 334 and flange 344 having an increased diameter, similar to connector 208.

Referring to FIG. 10, a portable unit 402 includes a female connector 16 and a reservoir 404 includes a male connector 210. Illustratively, male connector 210 is shown as being generally smaller than female connector 16 and not able to properly couple to female connector 16 without the aid of adapter 400. However, it should be appreciated that male connector may be the correct size to couple female connector 16 or may be larger than female connector 16 such that an adapter 300 is required.

Adapter 400 includes a body portion 406, a valve shaft 436 and associated retaining clip 421, a first valve 408, a second valve 410, a first sleeve 412, and a second sleeve 414. Seals 416 and 418 are provided between body portion 406 and first sleeve 412 and second sleeve 414, respectively. As shown in FIG. 10, first sleeve 412 is adapted to be received by recess 80 of female connector 16 and body portion 406 and second sleeve 414 cooperate to receive cylindrical portion 282 of male connector 210.

Second valve 410 is illustratively shown as having a first seal 420, a first guide 422, and a second guide 424. In alternative embodiments, second valve 418 only includes a single guide, similar to male connector 18. Valve 410 is biased in direction 427 by a biasing member, spring 428. Spring 428 is compressed between first guide 422 and second guide 424.

First valve 408 is illustratively shown as having a first seal 432 and a single guide 434. Single guide 434 is a portion of valve shaft 436 which is a part of second valve 410. Single guide 434 is received into a recess 438 of valve shaft 440 of first valve 410. Valve 408 is biased in direction 426 by a biasing member, spring 442. Spring 442 is compressed between guide 424 and flange 444 of valve shaft 440. It should be noted that an end 446 of valve shaft 440 is spaced apart from second guide 424 when valve 430 is in the closed position such that second guide member 424 does not block valve 430 from moving to the open position in direction 427. In alternative embodiments, second valve 430 includes multiple guides, such as guide 434 and flange 444 having an increased diameter, similar to connector 210.

1. A connector for use with a fluid system, the connector being adapted to be coupled to a first fluid storage device and being further adapted to interface with a second connector, the second connector being adapted to be coupled to a second fluid storage device, such that fluid may pass through the connector from one of the first fluid storage device and the second fluid storage device to the other of the first fluid storage device and the second fluid storage device, the connector comprising:
a body having a first end adapted to be coupled to the first fluid storage device and a second end adapted to interface with the second connector, the body having a central fluid conduit which connects the first end and the second end and having a valve seat positioned in the fluid conduit;
a valve positioned in the fluid conduit and moveable along a central axis of the fluid conduit, the valve configured to cooperate with the valve seat to prevent the flow of fluid through the fluid conduit when the valve is in a first position and to permit the flow of fluid through the fluid conduit when the valve is in a second position;
a first valve guide positioned in the fluid conduit, the first valve guide configured to support the valve generally adjacent a first end of the valve;
a second valve guide positioned in the fluid conduit between the first valve guide and the valve seat of the body, the second valve guide configured to support the valve generally adjacent a second end of the valve, and
a biaser positioned between the first valve guide and the second valve guide and configured to bias the valve to the second position, wherein the first valve guide and the second valve guide are each configured to generally align an axis of the valve with the central axis of the body as the valve moves between the first position and the second position.

2. The connector of claim 1, wherein the separation between the first valve guide and the second valve guide is increased when the valve is in the first position.

3. The connector of claim 1, wherein the valve includes a valve shaft and the first valve guide is fixably coupled to the body and the second valve guide is fixably coupled to the valve shaft.

4. The connector of claim 3, wherein an outer radial extent of the second valve guide is generally approximate to a diameter of the fluid conduit of the body such that transverse movement of the second end of the valve is minimized.

5. The connector of claim 4, wherein the valve further includes a first seal positioned adjacent the second valve guide, the first seal being configured to cooperate with the valve seat to prevent the flow of fluid through the fluid conduit when the valve is in a first position.

6. The connector of claim 5, wherein the valve further includes a second seal positioned adjacent the first valve guide, the second seal being configured to cooperate with a second valve seat of the body to prevent the flow of fluid through the fluid conduit when the valve is in a first position.

7. The connector of claim 6, wherein the body is configured to receive a corresponding male connector, the body having a recess located generally proximate to the second end, the recess sized to receive the corresponding male connector.

8. The connector of claim 7, wherein a tip of the second end of the valve extends into the recess.

9. The connector of claim 6, wherein the body is configured to be received by a corresponding female connector.

10. A connector for use with a fluid system, the connector being adapted to be coupled to a first fluid storage device and being further adapted to interface with a second connector, the second connector being adapted to be coupled to a second fluid storage device, such that fluid may pass through the connector from one of the first fluid storage device and the second fluid storage device to the other of the first fluid storage device and the second fluid storage device, the connector comprising:
a body having a first end adapted to be coupled to the first fluid storage device and a second end adapted to interface with the second connector, the body having a fluid conduit which connects the first end and the second end and having a valve seat positioned adjacent the recess;
a first valve guide positioned in the fluid conduit distal to the valve seat of the body and fixably coupled to the body;
a second valve guide positioned in the fluid conduit between the first valve guide and the valve seat of the body and being moveable relative to the body;
a valve having a valve shaft which is moveably coupled to the first valve guide and fixably coupled to the second valve guide,
a first seal coupled to the valve, the valve being movable between a first position wherein the seal is spaced apart from valve seat of the body and a second position wherein the seal and the valve seat cooperate to form a seal; and
a biaser positioned between the first valve guide and the second valve guide and configured to bias the valve to the second position.

11. The connector of claim 10, wherein the first valve guide includes at least one fluid conduit.

12. The connector of claim 10, wherein the second guide member includes at least one fluid conduit.

13. The connector of claim 10, wherein the biaser is a spring.

14. The connector of claim 10, further including a second seal positioned adjacent the first valve guide, the second seal being configured to cooperate with a second valve seat of the body to prevent the flow of fluid through the fluid conduit when the valve is in a first position.

15. The connector of claim 14, wherein the second seal body is spaced apart from the second valve seat when the valve is in the first position and the second seal and the second valve seat cooperate to form a second seal when the valve is in the second position.
